(19) United States
(12) Patent Application Publication
(10) Pub. No.: US 2025/0327720 A1
(43) Pub. Date: Oct. 23, 2025

(54) BICYCLE SUSPENSION SENSOR CALIBRATION AND USE

(71) Applicant: Motion Instruments, Inc., Redwood City, CA (US)

(72) Inventor: Michael John Chartier, Plymouth, MN (US)

(21) Appl. No.: 18/638,462

(22) Filed: Apr. 17, 2024

(51) Int. Cl. G01M 17/04; B62J 45/413; B62J 45/42; B62K 25/30; G01B 7/30

(52) U.S. Cl. CPC G01M 17/04; B62J 45/413; B62J 45/42; G01B 7/30; B62K 25/30

(57) ABSTRACT

Systems and methods are provided for generating, using first sensor data from an angle sensor coupled to a bicycle, first angle data representing an extended state of a rear suspension of the bicycle, generating, using second sensor data from the angle sensor, second angle data representing a compressed state of the rear suspension, generating, using the first angle data and the second angle data, calibration data representing a direction of rotation detected by the angle sensor, and a flag regarding whether the angle sensor has detected rotation past a checkpoint, and generating performance data based on the calibration data and third sensor data from the angle sensor.

### BACKGROUND

Many bicycles, particularly mountain bikes, are equipped with suspensions. For example, a suspension may include a front suspension and/or a rear suspension, and the suspension (e.g., the front suspension and/or the rear suspension) may include one or more shock absorbers. Further, suspension characteristics of a suspension (e.g., a front suspension and/or a rear suspension) may be adjustable to modify (e.g., optimize) a performance of the suspension (e.g., the front suspension and/or the rear suspension), such as, for example, by adjusting the shock absorber(s) of the suspension.

Front suspensions typically include one or more shock absorbers integrated with a front fork of a bicycle. The front fork can hold a front wheel of the bicycle, and the shock absorber(s) can absorb and damp shock impulses received by the front wheel of the bicycle. Meanwhile, rear suspensions typically include a rear frame portion (e.g., a rear triangle) of a bicycle that is configured to pivot with respect to a front frame portion (e.g., a front triangle) of the bicycle, and one or more shock absorbers coupled between the front frame portion and the rear frame portion. The rear frame portion can hold a rear wheel of the bicycle, and the shock absorber(s) can absorb and damp shock impulses received by the rear wheel of the bicycle. Further, the rear frame portion includes one or more frame members and may include one or more pivot points to achieve a desired path and range of travel of the rear wheel when the rear frame portion pivots with respect to the front frame portion.

The shock absorber(s) of the suspension (e.g., the front suspension and/or the rear suspension) may include a tube or shaft coupled to a piston within a cylinder. The cylinder may contain a suspension fluid for damping. In many examples, one or more adjustable valves or orifices in the shock absorber may regulate passage of the suspension fluid as the piston moves within the cylinder, and adjusting the valve(s) and/or orifice(s) can adjust suspension characteristics of the shock absorber(s) and the suspension (e.g., the front suspension and/or the rear suspension).

Cyclists typically rely on trial and error to determine how to adjust suspension characteristics of a suspension (e.g., a front suspension and/or a rear suspension) of the bicycle to achieve a desired performance of the suspension (e.g., the front suspension and/or the rear suspension). However, by understanding the behavior of a bicycle and/or a suspension (e.g., a front suspension and/or a rear suspension) of the bicycle, a cyclist can better (e.g., more accurately) adjust the suspension characteristics of the suspension (e.g., the front suspension and/or the rear suspension) to achieve desired performance. For example, being able to accurately determine (e.g., measure), and thereby monitor a position and/or a change in position of a front and/or rear wheel of the bicycle and/or of shock absorber(s) of a suspension (e.g., a front suspension and/or a rear suspension) of the bicycle can help a cyclist to better (e.g., more accurately) adjust suspension characteristics of the suspension (e.g., the front suspension and/or the rear suspension) of the bicycle. Determining or monitoring a position and/or a change in position of a rear wheel of a bicycle and/or of the shock absorber(s) of a rear suspension of the bicycle can be particularly challenging as a result of the arcuate movement of the rear wheel. Existing sensors and techniques for determining and monitoring a position and/or a change in position of a rear wheel of a bicycle and/or of the shock absorber(s) of a rear suspension of the bicycle have suffered from various drawbacks, such as, for example, requiring predetermined information about the geometry of bicycles on which the sensors are mounted and/or requiring information of the positions and/or orientations of the sensors as mounted on the bicycles.

### SUMMARY

In some aspects, the techniques described herein relate to a system for calibrated monitoring of a bicycle suspension, the system including: an angle sensor configured to be coupled to a bicycle in a plurality of orientations with respect to a rear suspension of the bicycle; and a non-transitory computer-readable storage medium including an application configured to program a computing device to: generate, using first sensor data from the angle sensor coupled to the bicycle, first angle data representing an extended state of the rear suspension; generate, using second sensor data from the angle sensor, second angle data representing a compressed state of the rear suspension; generate, using the first angle data and the second angle data, calibration data representing: a direction of rotation detected by the angle sensor; and a flag regarding whether the angle sensor has detected rotation past a checkpoint; and generate performance data based on the calibration data and third sensor data from the angle sensor.

In some aspects, the techniques described herein relate to a non-transitory machine-readable storage medium storing instructions executable by one or more processors of a computing device, wherein the instructions, when executed by the one or more processors, cause the computing device to: generate, using first sensor data from an angle sensor coupled to a bicycle, first angle data representing an extended state of a rear suspension of the bicycle; generate, using second sensor data from the angle sensor, second angle data representing a compressed state of the rear suspension; generate, using the first angle data and the second angle data, calibration data representing: a direction of rotation detected by the angle sensor; and a flag regarding whether the angle sensor has detected rotation past a checkpoint; and generate performance data based on the calibration data and third sensor data from the angle sensor.

In some aspects, the techniques described herein relate to a computer-implemented method including: under control of a computing device including one or more processors configured to execute specific instructions: generating, using first sensor data from an angle sensor coupled to a bicycle, first angle data representing an extended state of a rear suspension of the bicycle; generating, using second sensor data from the angle sensor, second angle data representing a compressed state of the rear suspension; generating, using the first angle data and the second angle data, calibration data representing: a direction of rotation detected by the angle sensor; and a flag regarding whether the angle sensor has detected rotation past a checkpoint; and generating performance data based on the calibration data and third sensor data from the angle sensor.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1 is a diagram depicting an illustrative environment in which a user computing device can communicate with a server and an angle sensor mounted to a bicycle according to some embodiments.

FIG. 2 is a block diagram of an illustrative user device in communication with an illustrative sensor device according to some embodiments.

FIG. 3 is a side view of an illustrative sensor assembly for determining and monitoring pivoting motion attached to a rear bicycle suspension according to some embodiments.

FIG. 4 is a flow diagram of an illustrative routine for calibration of a sensor according to some embodiments.

FIG. 5 illustrates angles sensed by an angle sensor mounted to a bicycle during a calibration operation according to some embodiments.

FIG. 6 illustrates angles sensed by an angle sensor mounted to a bicycle during a calibration operation according to some embodiments.

FIG. 7 illustrates angles sensed by an angle sensor mounted to a bicycle during a calibration operation according to some embodiments.

FIG. 8 illustrates angles sensed by an angle sensor mounted to a bicycle during a calibration operation according to some embodiments.

FIG. 9 is a flow diagram of an illustrative routine for determining a position of a rear bicycle wheel using a calibrated sensor according to some embodiments.

### DETAILED DESCRIPTION OF ILLUSTRATIVE EMBODIMENTS

The present disclosure relates to calibrating sensors for rear suspensions of bicycles, and using the calibrated sensors to understand the behavior of the rear suspensions and bicycles. For example, the calibrated sensors can be used to determine (e.g., measure, calculate) and monitor the degree of rear shock extension and compression, and corresponding rear wheel position, and suspension characteristics. More specifically, aspects of the present disclosure relate to calibrating angle sensors configured to be mounted to bicycles in various positions and orientations. Advantageously, the calibration systems and methods of the present disclosure allow for calibration of such sensors in substantially any position or orientation in which the sensors may be mounted, without requiring users to provide information regarding the positions or orientations in which they have mounted the sensors.

Determining (e.g., measuring, calculating) and monitoring rear shock extension and compression, and corresponding rear wheel position, and suspension characteristics, may be useful for a variety of applications, including informing adjustments to improve or optimize a performance of a bicycle and its suspension. Exemplary suspension characteristics that can be determined and/or monitored include the positions and speed of the rear shock movement, resting position (e.g., static sag) of the rear shock; average position while riding (e.g., dynamic sag) of the rear shock; a histogram of the rear shock position over time; speed of compression strokes and rebound strokes; position of maximum speed of the strokes; and balance between front and rear suspension strokes.

Some conventional products are available to determine a bicycle rear shock and/or rear wheel position. However, such products may be difficult to mount to a bicycle. For example, the products may be required to be mounted in a specific location of the bicycle frame or shock, and/or a specific orientation with respect to the frame or shock. An additional drawback of such products is that they may suffer from inaccuracies or damage due to mud and water. Such a drawback can be significant when used in an offroad environment, where mud and water may be commonly encountered. A further drawback of such products is that they may require predetermined and/or additional information about the geometry of the bicycle in order to generate accurate data regarding rear shock and/or rear wheel position.

Some aspects of the present disclosure address some or all of the problems noted above, among others, through use of an angle sensor that may be placed in a variety of different positions and orientations on a bicycle. A dynamic calibration routine may be used to properly calibrate the angle sensor regardless of the position or orientation in which the sensor is installed. In some embodiments, application software executing on a user computing device may instruct a user to fully extend the bicycle suspension (e.g., by lifting the bicycle off the ground) and at least partially compress the bicycle suspension (e.g., by sitting on the bicycle or pushing down on the seat). During these extension and compression operations, the angle sensor may generate sensor data representing samples of angles detected throughout the operations. Based on the sensor data, the application may automatically determine the position and orientation of the sensor as mounted on the bicycle. For example, depending upon how the angles change during the extension and compression operations, the application may determine whether the sensor is oriented such that the angles change in a clockwise or counterclockwise direction during compression as opposed to extension. In addition, using the sensor data and predetermined bicycle geometry data (e.g., maximum shock travel, maximum wheel travel), the application can automatically determine the position of the rear shock and rear wheel during use. In this way, the application may provide a variety of suspension characteristics.

In some embodiments, the application may not use predetermined bicycle geometry to calibrate the sensor and determine and monitor rear shock and rear wheel positions, and suspension characteristics. Thus, the application and sensor may be used with different bicycle models that are new or for which bicycle geometry is otherwise unknown. For example, during calibration the application may prompt the user to fully compress the rear suspension, rather than partially compress the suspension. From the fully compressed state, the application can determine the maximum shock travel, and use the value in order to provide the same suspension characteristics as when bicycle geometry is known in advance.

Various aspects of the disclosure will now be described with regard to certain examples and embodiments, which are intended to illustrate but not limit the disclosure. Although the examples and embodiments described herein will focus, for the purpose of illustration, on specific angle sensors, calculations and algorithms, one of skill in the art will appreciate the examples are illustrative only, and are not intended to be limiting. In addition, any feature, process, device, or component of any embodiment described and/or illustrated in this specification can be used by itself, or with or instead of any other feature, process, device, or component of any other embodiment described and/or illustrated in this specification, without limitation.

### Example Usage Environment

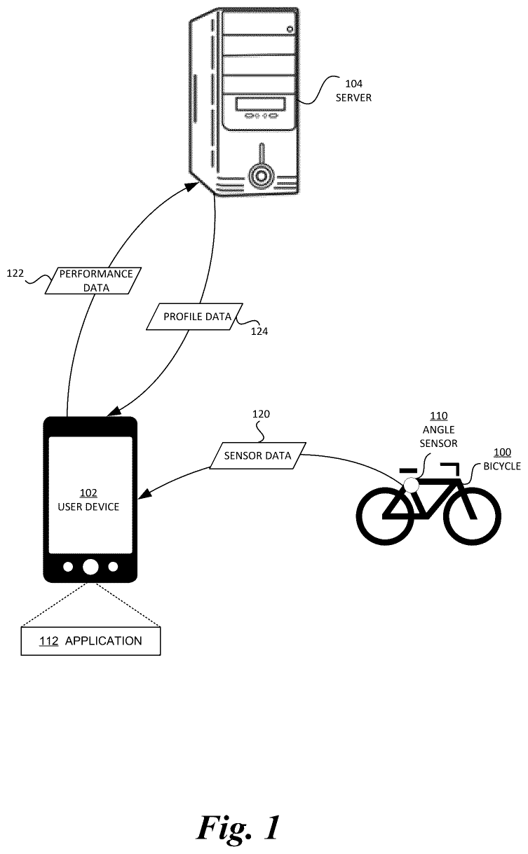

With reference to an illustrative embodiment, FIG. 1 shows an environment in which aspects of the present disclosure may be implemented. As shown, a bicycle 100 may have a sensor device 110 configured to communicate with a user device 102. In some embodiments, the user device 102 may be configured to communicate with a server 104 in addition to the sensor device 110.

The sensor device 110 may communicate with the user device 102 via one or more wired or wireless connections. For example, the user device 102 and sensor device 110 may each have wireless transceivers configured to communicate via a wireless communication protocol, such as Bluetooth® or Wi-Fi. The user device 102 and server 104 may communicate via one or more wired or wireless communication networks. For example, a communication network may be a publicly-accessible network of linked networks, possibly operated by various distinct parties, such as the Internet. In some cases, the communication network may include a private network, personal area network, local area network, wide area network, cable network, satellite network, cellular data network, etc., or a combination thereof, some or all of which may or may not have access to and/or from the Internet.

The user device 102 may be or include any type of computing system, such as a mobile device (for example, a laptop, smart phone, personal digital assistant, tablet, or the like), a desktop, a wearable device (for example, a smart watch or glasses with computing functionality), a dedicated sensor control device, to name a few. The user device 102 can execute an application 112, such as a browser or an application software (such as a native application or a progressive web application) that may be downloaded from an application marketplace or remote server (such as the server 104). The application 112 can obtain sensor data 120 from the sensor device 110, generate calibration data for use in processing the sensor data 120 into performance data 122, and perform various actions using the performance data 122. For example, the user device 102 may generate displays of the performance data 122, send the performance data to the server 104, perform other actions, or any combination thereof. Example routines for generating calibration data and performance data using sensor data are described in greater detail below.

In some embodiments, the server 104 may act as a repository of data for multiple users. For example, the server 104 may store profile data 124 for individual users, allowing users to access their profiles remotely from different devices, access or backup performance data 122 remotely from different devices, and the like. As another example, the server 104 may maintain bicycle geometry information for various bicycles, and the user device 102 may obtain bicycle geometry information from the server 104 during a calibration procedure, as described in greater detail below.

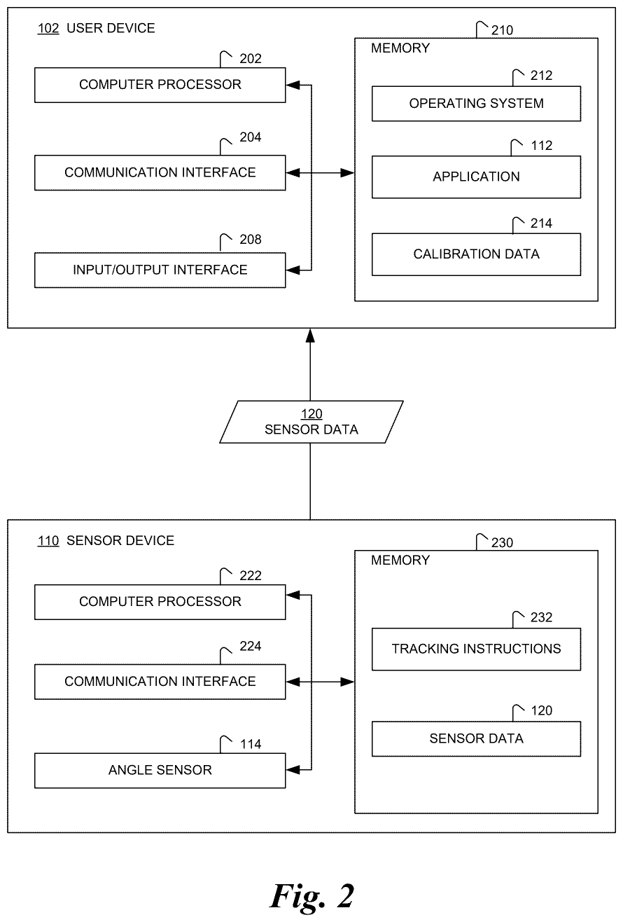

FIG. 2 illustrates example components of a user device 102. In some embodiments, as shown, the user device 102 may include: one or more computer processors 202, such as physical central processing units (CPUs); one or more communication interfaces 204, such as a network interface cards (NICs) with one or more wireless communication transceivers; an input/output interface 208 configured to control a display and user controls; and one or more computer-readable memories 210, such as random-access memory (RAM), flash memory, and/or other non-transitory computer-readable media.

The computer-readable memory 210 may include specific instructions (e.g., computer program instructions) that one or more computer processors 202 execute in order to implement one or more embodiments. The computer-readable memory 210 can store an operating system 212 that provides computer program instructions for use by the computer processor(s) 202 in the general administration and operation of the user device 102. The computer-readable memory 210 may also include an application 112 for evaluating sensor data 120 from a sensor device, generating calibration data 214 and/or performance data 122, and the like.

FIG. 2 also illustrates various components of an example sensor device 110. In some embodiments as shown, the sensor device 110 may include: one or more computer processors 222, such as physical CPUs; one or more communication interfaces 224, such as a Wi-Fi, Bluetooth®, or other wireless communication transceivers; one or more sensors, such as an angle sensor 114, and one or more computer-readable memories 230, such as RAM, flash memory, and/or other non-transitory computer-readable media. The computer-readable memory 230 may include specific instructions (e.g., computer program instructions) that one or more computer processors 222 execute in order to implement one or more embodiments. The computer-readable memory 230 can store tracking instructions 232 for use in the general administration and standard operation of the sensor device 110, such as generating sensor data 120 using the angle sensor 114.

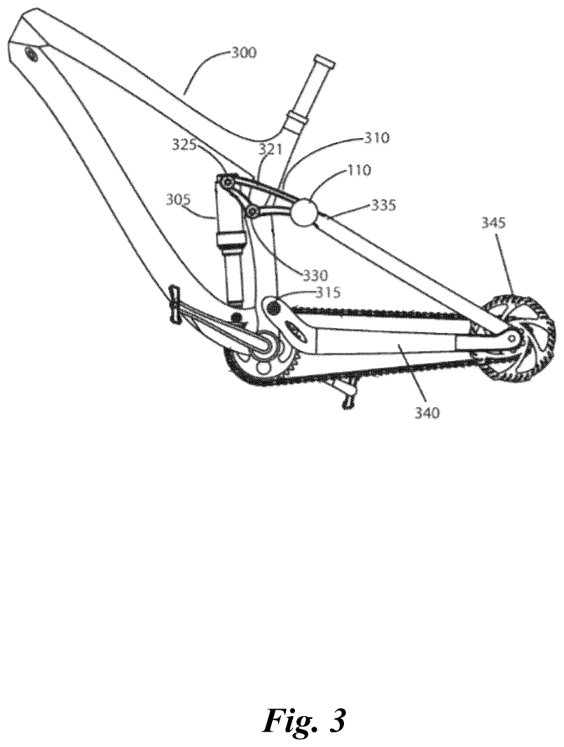

FIG. 3 illustrates one embodiment of a sensor device 110 installed on a bicycle 100. The sensor device 110 is shown installed at one of several possible attachment locations. As rear suspensions vary considerably in structure and operation, the illustrated suspension is provided as a non-limiting example. In the illustrated example, the frame 300 includes a pivoting upper support 335 and a pivoting lower support 340. The upper support 335 also may be referred to as a seat stay, and the lower support 340 may be referred to as a chainstay. The frame 300 further includes a triangle 310, and the triangle 310 includes a linkage 321. The upper support 335 is pivotally coupled to triangle 310 at a first end and pivotally coupled to the lower support 340 at a second end. The upper support 335 is pivotally coupled to triangle 310 by a bolt, which is concealed by the sensor device 110. The lower support 340 is pivotally coupled to a seat tube of the frame 300 at a first end and to the upper support 335 at a second end. The lower support 340 is pivotally coupled to the seat tube of the frame 300 by a bolt 315. Triangle 310 is pivotally coupled to the seat tube of the frame 300 by a bolt 330. Further, a damper or shock absorber 305 can be pivotally coupled to the triangle 310 by a bolt 325, and to a downtube of the frame 300 by another bolt. The upper support 335 is pivotally coupled to the lower support 340, and vice versa, by a bolt. The bolt also can mount a rear wheel to the upper support 335 and the lower support 340. In other embodiments, the rear wheel can be received by one of the upper support 335 or the lower support 340 so that the axle of the rear wheel is not co-located with the bolt coupling together the upper support 335 and the lower support 340. A brake rotor 345 for the rear wheel can be mounted to the frame 300 and coaxial with an axis of the rear wheel. The triangle 310 is configured to pivot relative to bolt 330, as the upper support 335 and the lower support 340 pivot in response to shock impulses received by the rear wheel such as when the rear wheel passes over bumps. The shock absorber 305 is configured to absorb and damp the shock impulses received by the rear wheel. A rear frame portion of the frame 300 can include the upper support 335, the lower support 340, and the triangle 310, and together with shock absorber 305 can form a rear suspension of a bicycle including the frame 300.

In some embodiments, the sensor device 110 includes a shank shaped for mating with a socket in a head of a bolt about which a portion of a rear suspension of a bicycle pivots. A magnetometer (or a permanent magnet) is coupled to the shank. A permanent magnet with a north pole and a south pole (or a magnetometer) is positioned adjacent to the magnetometer (or permanent magnet) and pivotable relative thereto. A linkage couples the permanent magnet (or magnetometer) to the portion of the rear suspension that pivots about the bolt. The magnetometer senses changes in the magnetic field as the suspension pivots. Such changes may be measured in terms of angular displacement from a particular checkpoint or reference point, which may be referred to as the zero reference point.

An exemplary sensor that can be implemented for sensor device 110 shown in FIG. 3 is described in further detail in U.S. Pat. No. 10,894,572, titled “Sensor Assembly for Pivoting Suspension of Bicycle” and issued on Jan. 19, 2021, which is incorporated by reference herein and made part of this specification. However, the sensor device shown in FIG. 3 is provided for purposes of illustration only, and is not intended to be limiting or required. In some embodiments, other types or configurations of sensors may implemented for the sensor device 110.

### Sensor Calibration

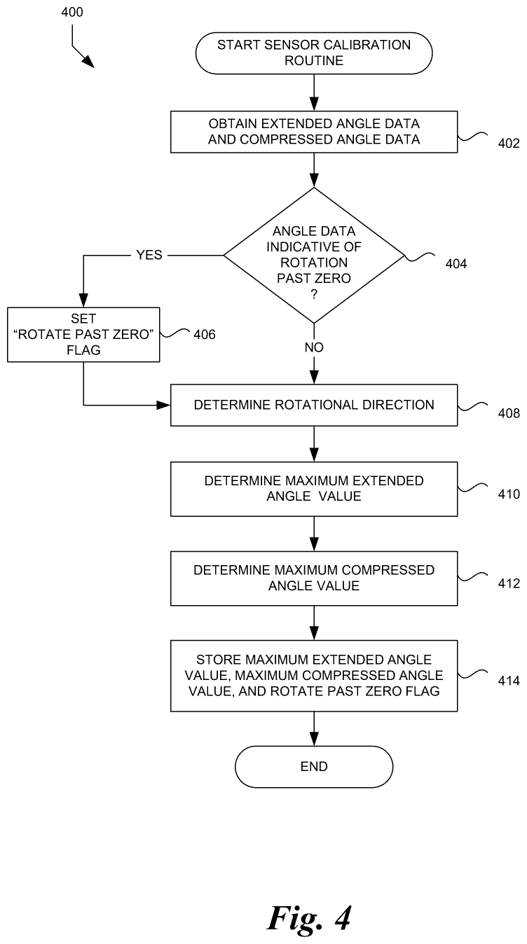

FIG. 4 is a flow diagram of an illustrative routine 400 that an application 112 executing on a user device 102 may perform to calibrate a sensor device 110. Advantageously, use of routine 400 allows for accurate sensor calibration without necessarily requiring the sensor device 110 to be installed in a specific location or orientation on a bicycle 100. Rather, a user can install the sensor device 110 in any of a range of locations or orientations, and the user does not need to provide to the application 112 information about the location or orientation at which the sensor device 110 is installed. Moreover, in some embodiments the routine 400 may be performed to calibrate a sensor device 110 for use with a bicycle for which bicycle geometry and other technical specifications are not readily available or predetermined.

The routine 400 may begin in response to an event, such as when a user starts application 112, when the user device 102 establishes a connection with the sensor device 110 that has not yet been calibrated, or when the user chooses an option within the application 112 to calibrate a new sensor device 110 or recalibrate an existing sensor device 110.

At block 402, the application 112 may obtain angle data from the sensor device 110. The angle data may be obtained in the form of sensor data 120 representing measurements of angular displacement (also referred to herein simply as “angles”) generated by the sensor device 110 at various points in time. For example, the sensor device 110 may be configured to sample the angle detected by the angle sensor 114. The sampling may occur on demand, or at various intervals (e.g., about every 10 milliseconds, about every 25 milliseconds, about every 100 milliseconds, etc.).

As described above, the angles may be measured with respect to a constant checkpoint or reference point, which may be referred to as the zero reference point. As a rear bicycle suspension extends and compresses, a particular structure of the sensor device 110 (e.g., a magnet or magnetometer) will pivot about a pivot point. Thus, a current angle observed by the sensor device 110 may be a measurement of the angular displacement of the structure with respect to the zero reference point. However, because a user may locate and orient the sensor device 110 on the bicycle in a variety of different ways, the reference point may differ from installation to installation. Thus, the angle data generated by a sensor device 110 installed on a bicycle may differ significantly from the angle data generated by the same sensor device 110 installed on a different bicycle (or installed in a different manner on the same bicycle), particularly if the sensor device 110 is oriented such that the zero reference point is in a different orientation. Thus, an angle represented by angle data does not, by itself, indicate how much pivot is detected by the sensor device 110 during rear suspension extension or compression. Rather, a comparison between two or more angles is used to determine a degree of extension or compression of the rear suspension, as described in greater detail below.

In some embodiments, the application 112 may instruct the user to perform various actions with respect to the rear suspension of the bicycle 100, and may instruct the sensor device 110 to sample the angle detected by the angle sensor 114 during performance of the actions. In this way, the angle data may be associated with the particular actions requested of the user, such as extending the rear suspension of the bicycle 100 and compressing the rear suspension of the bicycle 100.

To obtain extended angle data representing an extended state of the bicycle suspension, the application 112 may instruct the user (e.g., via graphical user interface display, audio playback, etc.) to fully lift the bicycle 100 off the ground, thus eliminating compression (e.g., sag) and putting the bicycle suspension into a fully extended state. During a time period for the user to extend the bicycle suspension, the sensor device 110 may generate sensor data regarding the angles sampled. For example, the sensor data may include a set of n samples corresponding to n sequential sampling periods, where n is a positive integer and each sampling period may be measured in milliseconds (e.g., 10 milliseconds, 25 milliseconds, 100 milliseconds, etc.). The application 112 may use this set of sensor data 120 as extended angle data.

To obtain compressed angle data, the application 112 may instruct the user (e.g., via graphical user interface display, audio playback, etc.) to at least partially compress the bicycle suspension, such as by pressing down on the seat, sitting on the seat, etc. During a time period for the user to compress the bicycle suspension, the sensor device 110 may generate sensor data regarding angles sampled. For example, the sensor data may include a set of m samples corresponding to m sequential sampling periods, where m is a positive integer and each sampling period may be measured in milliseconds (e.g., 10 milliseconds, 25 milliseconds, 100 milliseconds, etc.). Additionally, m may be greater than, less than, or equal to n. The application 112 may use this set of sensor data 120 as compressed angle data.

The extended angle data and compressed angle data will be used to determine various calibration settings, as described in greater detail below. One such calibration setting that the application 112 determines is the maximum compressed angle for the rear bicycle suspension. If bicycle technical specifications (e.g., bicycle geometry information) are available for the bicycle 100 on which the sensor device 110 is installed, the application 112 may use certain data items of such bicycle specifications to determine calibration settings (e.g., using maximum suspension travel to determine maximum compressed angle value). However, if bicycle specifications are not available for the current bicycle 100 (e.g., the bicycle is a new model or otherwise a model for which specifications are not automatically available to the application 112), then the application 112 may instruct the user to fully compress the rear suspension of the bicycle 100, rather than partially compressing the rear suspension. For example, full compression of the rear suspension may involve partial disassembly so that the suspension can be fully compressed without excessive force or weight being applied by the user.

In some embodiments, the extended angle data may be obtained before the compressed angle data. For example, the application 112 may instruct the user to extend the bicycle suspension first, and may not instruct the user to compress the bicycle suspension until after sensor data is received during a time period for bicycle suspension extension. In some embodiments, the compressed angle data may be obtained before the extended angle data. For example, the application 112 may instruct the user to compress the bicycle suspension first, and may not instruct the user to extend the bicycle suspension until after sensor data is received during a time period for bicycle suspension compression.

At decision block 404, the application 112 may determine whether the angle data (e.g., extended angle data and compressed angle data obtained at block 402) is indicative of a rotate-past-zero condition. In angle data generated by the sensor device 110, “rotate past zero” refers to a condition in which one or more of the angles sampled by the sensor device 110 occur on one side of a reference point corresponding to zero (0) degrees, while one or more other angles sampled by the sensor device 110 during the same calibration procedure occur on the other side of the reference point (e.g., one angle is 16 degrees, while another angle is 348 degrees). Because the rear bicycle suspension does not pivot a full 360 degrees-even from full extension to full compression-observing a difference of 200-300 degrees (or more) between minimum and maximum angles indicates that the true range of suspension pivot extends across the zero reference point (e.g., the measurement of suspension pivot crossed from one side of the reference point to the other while staying within about 90 degrees of the reference point at all times, rather than truly spanning more than 200 degrees without crossing the reference point). Indeed, many or all bicycle suspensions are expected to exhibit a range of pivoting that spans less than 90 degrees from full extension to full compression.

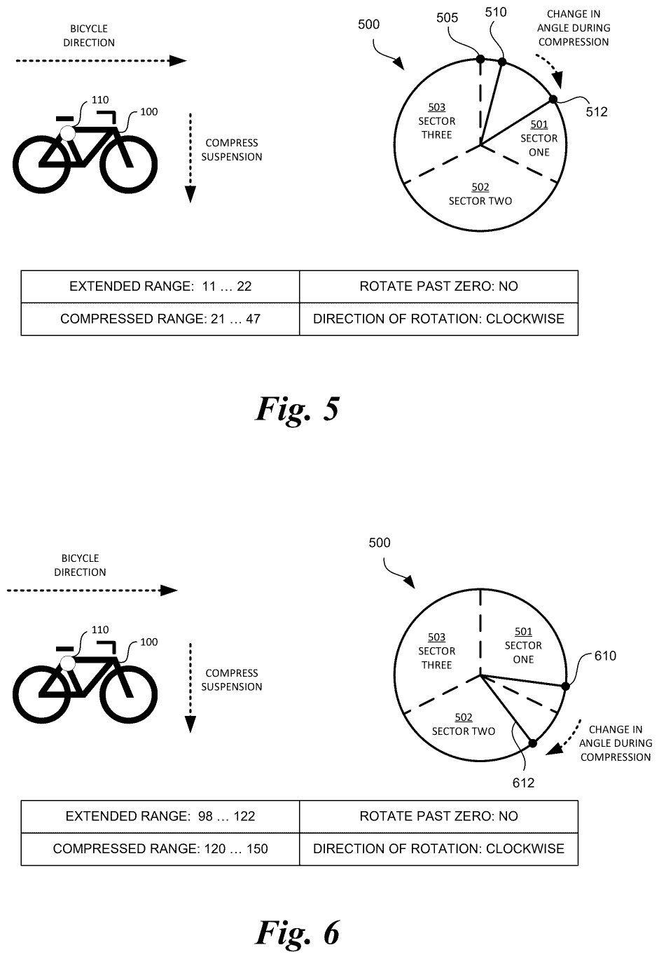

FIGS. 5-8 illustrate visualizations of some angles sampled by the sensor device 110 during different calibration procedures involving different orientations of the sensor device 110 with respect to the rear bicycle suspension. In the visualizations, the angles are indicated on a circle 500 representing the full 360 degrees of angular displacement that may be detected by the sensor device 110. Each individual angle output by the sensor device 110 is indicated with a solid straight line extending from the center of circle 500 to the outer circumference, where the intersection with the outer circumference is indicated by a point. The angles—such as angles 510 and 512 in FIG. 5—are shown as the angular displacement from a zero reference point 505. Illustratively, angle 510 corresponds to a measurement of about 11 degrees, and angle 512 corresponds to a measurement of about 47 degrees.

Circle 500 has been separated into multiple sectors: sector one 501, sector two 502, and sector three 503. Sector one 501 may be considered to encompass a first subset of the 360 degrees of angles that may be sampled by the sensor device (e.g., 0 through 119 degrees), sector two 502 may be considered to encompass a second subset (e.g., 120 through 239 degrees), and sector three may be considered to encompass a third subset (e.g., 240 through 359 degrees). The zero reference point 505 is positioned at the boundary between sector one 501 and sector three 503. To determine whether a rotate-past-zero condition has occurred, the application 112 may determine which sectors the angles sampled by the sensor device 110 occur within. If all angles are within a single sector (e.g., any individual sector of the three sectors), then a rotate-past-zero condition is not present. If the angles occur within two sectors, then a rotate-past-zero condition may occur depending on the particular sectors: if the angles occur within sector one 501 and sector three 503, then a rotate-past-zero condition has occurred because the boundary between sectors one and three corresponds to zero degrees; otherwise, a rotate-past-zero condition has not occurred. If angles are detected within all three sectors, then an error has occurred and in some embodiments may be reported to the user.

Although circle 500 is shown with three sectors of the same size, the example is provided for purposes of illustration only, and is not intended to be limiting, required, or exhaustive. In some embodiments, four, five, or more sectors may be used. In addition, or alternatively, some sectors may be sized differently from other sectors.

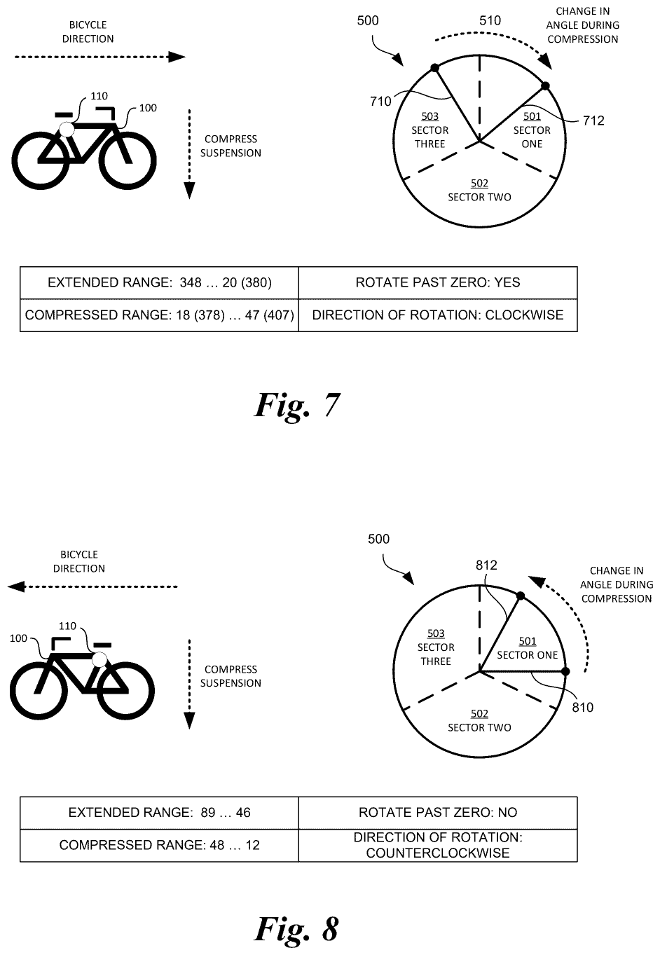

In the example illustrated in FIG. 5, representative angle 510 is in sector one 501. Representative angle 512 is also in sector one 501. Thus, a rotate-past-zero condition is not present. In the example illustrated in FIG. 6, representative angle 610 is in sector one 501. Representative angle 612 is in sector two 502. Thus, a rotate-past-zero condition is not present even though the angles are observed across two different sectors. In the example illustrated in FIG. 7, representative angle 710 is in sector three 503. Representative angle 712 is in sector one 501. Thus, a rotate-past-zero condition is present. In the example illustrated in FIG. 8, representative angle 810 is in sector one 501. Representative angle 812 is also in sector one 501. Thus, a rotate-past-zero condition is not present because the angles are observed in the same sector.

If a rotate-past-zero condition is present, routine 400 proceeds to block 406 where a rotate-past-zero flag is set for future use. Otherwise, if a rotate-past-zero condition is not present, routine proceeds to block 408.

In some embodiments, the rotate-past-zero flag may be set in cases where the angle data obtained during calibration does not necessarily fall into both sector one and sector three. For example, if the range of angle values obtained from the sensor device 110 during the calibration procedure is from 0.0 to 30.0 inclusive, then all values are in sector one and a rotate-past-zero condition would not be triggered based on the processing described above. However, during use of the bicycle 100, the sensor device 110 may generate values slightly outside of this range (e.g., 359.0 to 31.0) for a variety of reasons, including lack of full extension or compression during the calibration procedure, lack of precision of the angle sensor, wear of the bicycle suspension, or the like. In this case, a rotate-past zero condition would not be triggered during calibration, and erroneous or anomalous output may be generated during use of the bicycle 100. A similar scenario may occur when all angle values are in sector three and close to the zero reference point (e.g., 330.0 to 359.0 inclusive). To prevent erroneous or anomalous output in these scenarios, the rotate-past-zero flag may be set if all angles observed during the calibration procedure are in sector one or all in sector three, or if angles observed during the calibration procedure are within a threshold distance from the zero reference point (e.g., within one degree, one and half degrees, etc.).

At block 408, the application 112 may determine the rotational direction by which the angles sensed by the sensor device 110 change during suspension compression. Implementation of this step allows users to install the sensor device 110 in a convenient orientation, rather than requiring installation in a specific orientation that results in always rotating a single direction (only clockwise or only counterclockwise) during compression. For example, depending upon the installation choices made by the user, compression may result in angle measurements either increasing in a clockwise direction around circle 500 with respect to angles representing an extended state, or decreasing in a counterclockwise direction around the circle 500 with respect to angles representing an extended state.

To determine rotational direction, the application 112 may determine the minimum and maximum values in the obtained sensor data, depending upon whether the rotate-past-zero flag is set. In the case that the rotate-past-zero flag is not set, if the minimum value is in the range of values in the extended angle data and the maximum value is in the range of values in the compressed angle data, then the rotational direction is clockwise. Otherwise, if the minimum value is in the range of values in the compressed angle data and the maximum value is in the range of values in the extended angle data, then the rotational direction is counterclockwise.

In the case that the rotate-past-zero flag has been set, then the values may be adjusted prior to the comparison described above. In some embodiments, if the rotate-past-zero flag is set, then 360 degrees may be added to any angle value in sector one 501. In this way, minimum values in sector three 503 and maximum values in sector one 501 (after adding 360 degrees) correspond to a clockwise rotation, as expected due to the maximum pivot being significantly less than 300 or even 200 degrees.

In the example illustrated in FIG. 5, the minimum angle—angle 510—is part of the extended range, and the maximum angle—angle 512—is part of the compressed range. In addition, the rotate-past-zero flag is not set. Thus, the direction of rotation during compression is clockwise.

In the example illustrated in FIG. 6, the minimum angle—angle 610—is part of the extended range, and the maximum angle—angle 612—is part of the compressed range. In addition, the rotate-past-zero flag is not set. Thus, the direction of rotation during compression is clockwise.

In the example illustrated in FIG. 7, the rotate-past-zero flag has been set. As a result, 360 degrees will be added to any angle value in sector one 501. The minimum angle—angle 710 in sector three 503—is part of the extended range, and the maximum angle—angle 712, which is greater than angle 710 once 360 degrees have been added due to angle 712 being in sector one 501—is part of the compressed range. Thus, the direction of rotation during compression is clockwise. This example illustrates the impact of the adjustment to angle values based on the rotate-past-zero flag: if 360 degrees had not been added to the angle values in sector one 501, then the maximum numerical value for any sensed angle would be in the extended range and the rotational direction would erroneously be determined to be counterclockwise, unless additional rules-based processing was implemented (e.g., an analysis of the magnitude of difference between angles, the expected maximum magnitude of difference between angles, etc.). The adjustment of values in sector one 501 allows the same processing to be used in all cases.

In the example illustrated in FIG. 8, the minimum angle—angle 812—is part of the compressed range, and the maximum angle—angle 810—is part of the extended range. In addition, the rotate-past-zero flag is not set. Thus, the direction of rotation during compression is counterclockwise.

At block 410, the application 112 may determine the maximum extended angle value. The “maximum” in maximum extended angle value refers to the maximum amount of extension rather than the maximum numeric value in the data set, although the maximum extended angle value may also be the maximum numeric value depending upon the factors used to determine the value. In some embodiments, the maximum extended angle value depends on several factors, including whether the rotate-past zero flag has been set, the sectors in which the values in the extended angle data occur, the rotational direction, and the extreme values in the extended angle data. If the rotate-past-zero flag has been set, then 360 is added to the value of any angles occurring in sector one. If the rotational direction is clockwise, then the minimum of all values in the extended angle data (as adjusted based on sector and rotate-past-zero flag, if needed) is selected as the maximum extended angle value. Otherwise, if the rotational direction is counterclockwise, then the maximum of all values in the extended angle data (as adjusted based on sector and rotate-past-zero flag, if needed) is selected as the maximum extended angle value.

At block 412, the application 112 may determine the maximum compressed angle value. The “maximum” in maximum compressed angle value refers to the maximum amount of compression rather than the maximum numeric value in the data set, although the maximum compressed angle value may also be the maximum numeric value depending upon the factors used to determine the value. In some embodiments, the maximum compressed angle value depends on several factors, including whether the rotate-past zero flag has been set, the sectors in which the values in the compressed angle data occur, the rotational direction, and the extreme values in the compressed angle data. If the rotate-past-zero flag has been set, then 360 is added to the value of any angles occurring in sector one. If the rotational direction is clockwise, then the maximum of all values in the compressed angle data (as adjusted based on sector and rotate-past-zero flag, if needed) is selected as the maximum compressed angle value. Otherwise, if the rotational direction is counterclockwise, then the minimum of all values in the compressed angle data (as adjusted based on sector and rotate-past-zero flag, if needed) is selected as the maximum compressed angle value.

Although block 412 is shown as occurring after block 410, the example is provided for purpose of illustration only and is not intended to be limiting or required. In some embodiments, block 410 (determination of maximum extended angle value) may be performed after, or in parallel with, block 412 (determination of maximum compressed angle value).

In the example illustrated in FIG. 5, the rotate-past-zero flag has not been set, and the direction of rotation is clockwise. Thus, the maximum extended angle is the minimum numeric value from the extended angle data, in this case 11 degrees. The maximum compressed angle is the maximum numeric value from the compressed angle data, in this case 47 degrees.

In the example illustrated in FIG. 6, the rotate-past-zero flag has not been set, and the direction of rotation is clockwise. Thus, the maximum extended angle is the minimum numeric value from the extended angle data, in this case 98 degrees. The maximum compressed angle is the maximum numeric value from the compressed angle data, in this case 150 degrees.

In the example illustrated in FIG. 7, the rotate-past-zero flag has been set, and the direction of rotation is clockwise. As a result, 360 will be added to any angle values in sector one. Thus, the maximum extended angle is the minimum numeric value from the extended angle data, in this case 348 degrees. The maximum compressed angle is the maximum numeric value from the compressed angle data as adjusted based on the rotate-past-zero flag, in this case 407 degrees (as adjusted from 47 degrees).

In the example illustrated in FIG. 8, the rotate-past-zero flag has not been set, and the direction of rotation is counterclockwise. Thus, the maximum extended angle is the maximum numeric value from the extended angle data, in this case 89 degrees. The maximum compressed angle is the minimum numeric value from the compressed angle data, in this case 12 degrees.

At block 414, the application 112 may store various calibration settings determined during routine 400 as calibration data 214. In some embodiments, the application 112 may store the maximum extended angle value, the maximum compressed angle value, and the rotate-past-zero flag. These calibration settings will be used to determine and monitor various rear wheel position and suspension characteristics during use of the bicycle, as described in greater detail below.

In some embodiments, the application 112 may store additional and/or alternative calibration settings as calibration data 214. For example, the application 112 may calculate settings such as the difference between the maximum extended angle value and the maximum compressed angle value. As another example, the application 112 may store data regarding the maximum wheel travel, maximum shock travel, or other information that is entered by a user during setup (e.g., during routine 400) or loaded in connection with predetermined bicycle specification data (e.g., from the server 104).

### Calibrated Generation of Performance Data of Rear Wheel Position and Suspension Characteristics

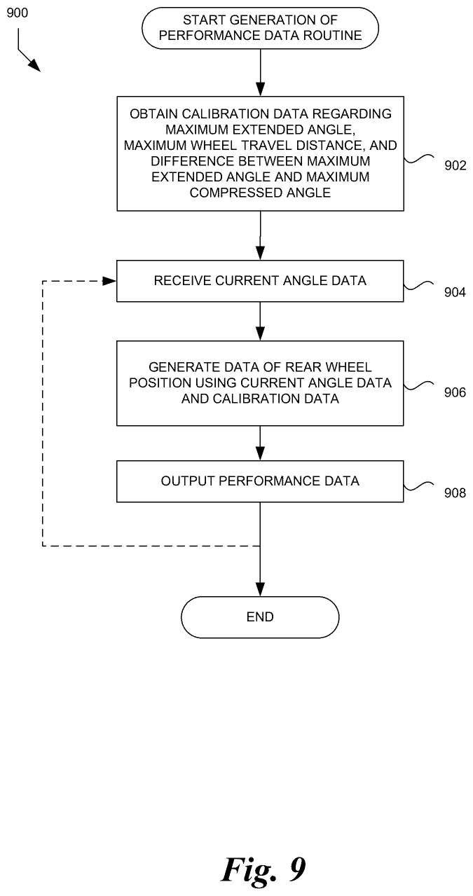

FIG. 9 is a flow diagram of an illustrative routine 900 that an application 112 executing on a user device 102 may perform to use a calibrated sensor device 110 to generate (e.g., determine, measure, calculate) performance data of rear wheel position and suspension characteristics during use of a bicycle 100.

The routine 900 may begin in response to an event, such as when a user starts application 112 or chooses an option within the application 112 to monitor a ride or otherwise generate performance data of rear wheel position or suspension characteristics.

At block 902, the application 112 may obtain calibration data (e.g., calibration settings or other configuration settings) for use in generating performance data of rear wheel position. In some embodiments, the application 112 may obtain the maximum extended angle value, the maximum compressed angle value, and the rotate-past-zero flag determined during calibration of the sensor device 110. In some embodiments, the application 112 may obtain additional and/or alternative calibration data. For example, the application 112 may obtain pre-calculated calibration data such as the difference between the maximum extended angle value and the maximum compressed angle value. As another example, the application 112 may obtain calibration data regarding the maximum wheel travel, maximum shock travel, or the like.

At block 904, the application 112 may receive current angle data from the sensor device 110. Current angle data may be a real-time or substantially real-time measurement of the current angle detected by the sensor device 110. In some embodiments, the current angle data may be received as a stream of samples (e.g., one sample every 10 milliseconds, 25 milliseconds, 100 milliseconds, etc.), and an iteration of the loop of operations illustrated in FIG. 9 may be performed for each sample. In some embodiments, the angle data may be received in a batch (e.g., after a ride) and processed sample-by-sample using an iteration of the loop of operations illustrated in FIG. 9 for each sample.

At block 906, the application 112 may use the calibration data for the sensor device 110 to generate data of the rear wheel position that corresponds to the current angle data.

As an initial step, the application 112 may determine if the rotate-past-zero flag is true, and the current angle is in sector one. If both are true, then the application 112 may add 360 to the numerical value of the current angle.

After adjusting for a rotate-past-zero condition if needed, the application 112 may determine a corrected angle based on the rotational direction of the bicycle suspension during compression. If the rotational direction is clockwise, then the corrected angle may be determined as the difference between the current angle value and the maximum extended angle value (e.g., Corrected_Angle=Current_Angle−A1, where A1=maximum extended angle). If the rotational direction is counterclockwise, then the corrected angle may be determined as the difference between the maximum extended angle and the current angle (e.g., Corrected_Angle=A1−Current_Angle). The correction is intended to always produce a corrected angle in the range of 0 to AA inclusive, where AA is the difference between A1 and A2, and were A2 is the maximum compressed angle. In this way, the application 112 may have a measurement of the degree of extension (or compression) of the rear bicycle suspension, without being biased due to the orientation of the sensor device 110.

Exemplary suspension characteristics that may be generated using the corrected angle include positions and speed of the rear shock movement, resting position (e.g., static sag) of the rear shock, average position while riding (e.g., dynamic sag) of the rear shock, a histogram of the rear shock position over time, speed of compression strokes and rebound strokes, position of maximum speed of the stroke, and balance between front and rear suspension strokes, among others.

At block 908, the application may output (e.g., display) performance data including the wheel positions and/or one or more suspension characteristics generated above. In some embodiments, the output may be presented via a graphical user interface. For example, the application 112 may output (e.g., display) the wheel positions and/or suspension characteristics in tabular form. As another example, the application 112 may output (e.g., display) wheel positions and/or suspension characteristics in graphical form, such as by displaying a histogram of rear shock position over time, a data plot of compression stroke speed zeniths, or the like. Additional examples of outputs (e.g., displays) of wheel positions and suspension characteristics that the application 112 may generate are described in U.S. Pat. No. 11,117,635, titled “System for Balancing Dampening Forces on a Suspension System” and issued on Sep. 14, 2021, the contents of which are incorporated by reference herein and made part of this specification.

### Terminology

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, read-only memory (“ROM”), erasable programmable read-only memory (“EPROM”), electrically erasable programmable read-only memory (“EEPROM”), registers, hard disk, a removable disk, a compact disc read-only memory (“CD-ROM”), or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system for calibrated monitoring of a bicycle suspension, the system comprising:
an angle sensor configured to be coupled to a bicycle in a plurality of orientations with respect to a rear suspension of the bicycle; and
a non-transitory computer-readable storage medium comprising an application configured to program a computing device to:
generate, using first sensor data from the angle sensor coupled to the bicycle, first angle data representing an extended state of the rear suspension;
generate, using second sensor data from the angle sensor, second angle data representing a compressed state of the rear suspension;
generate, using the first angle data and the second angle data, calibration data representing:
a direction of rotation detected by the angle sensor; and
a flag regarding whether the angle sensor has detected rotation past a checkpoint; and
generate performance data based on the calibration data and third sensor data from the angle sensor.

2. The system of claim 1, wherein the application is further configured to program the computing device to:
determine whether at least a first angle represented by the first sensor data is in a first sector of angles on a first side of the checkpoint, wherein the checkpoint corresponds to a zero reference point within a range of possible angles;
determine whether at least a second angle represented by the second sensor data is in a second sector of angles on a second side of the checkpoint; and
based on the first angle being in the first sector and the second angle being in the second sector, determine a value for the flag indicating the angle sensor has detected rotation past the checkpoint.

3. The system of claim 2, wherein the application is further configured to program the computing device to adjust values of angles in the first sector of angles based on the flag.

4. The system of claim 1, wherein the application is further configured to program the computing device to:
determine whether a maximum angle value observed during a calibration procedure is in the first angle data or the second angle data; and
determine the direction of rotation based on which of the first angle data or second angle data includes the maximum angle value observed during the calibration procedure.

5. The system of claim 1, wherein the application is further configured to program the computing device to:
determine whether a minimum angle value observed during a calibration procedure is in the first angle data or the second angle data; and
determine the direction of rotation based on which of the first angle data or second angle data includes the minimum angle value observed during the calibration procedure.

6. The system of claim 1, wherein the application is further configured to program the computing device to determine, using the first angle data and the second angle data, a difference between a maximum extended angle associated with the rear suspension and a maximum compressed angle associated with the rear suspension, wherein the calibration data further comprises the difference.

7. The system of claim 1, wherein the application is further configured to program the computing device to:
determine that bicycle specification data associated with the bicycle is not available;
generate a user prompt to fully compress the rear suspension, wherein the second sensor data represents angle sensor samples generated during a time period to fully compress the rear suspension; and
determine a maximum compressed angle value for the rear suspension based on the second sensor data.

8. The system of claim 1, wherein the application is further configured to program the computing device to:
determine that bicycle specification data associated with the bicycle is available; and
determine a maximum compressed angle value for the rear suspension based on the bicycle specification data.

9. A non-transitory machine-readable storage medium storing instructions executable by one or more processors of a computing device, wherein the instructions, when executed by the one or more processors, cause the computing device to:
generate, using first sensor data from an angle sensor coupled to a bicycle, first angle data representing an extended state of a rear suspension of the bicycle;
generate, using second sensor data from the angle sensor, second angle data representing a compressed state of the rear suspension;
generate, using the first angle data and the second angle data, calibration data representing:
a direction of rotation detected by the angle sensor; and
a flag regarding whether the angle sensor has detected rotation past a checkpoint; and
generate performance data based on the calibration data and third sensor data from the angle sensor.

10. The non-transitory machine-readable storage medium of claim 9, wherein the instructions, when executed by the one or more processors, further cause the computing device to:
determine whether at least a first angle represented by the first sensor data is in a first sector of angles on a first side of the checkpoint, wherein the checkpoint corresponds to a zero reference point within a range of possible angles;
determine whether at least a second angle represented by the second sensor data is in a second sector of angles on a second side of the checkpoint; and
based on the first angle being in the first sector and the second angle being in the second sector, determine a value for the flag indicating the angle sensor has detected rotation past the checkpoint.

11. The non-transitory machine-readable storage medium of claim 10, wherein the instructions, when executed by the one or more processors, further cause the computing device to adjust values of angles in the first sector of angles based on the flag.

12. The non-transitory machine-readable storage medium of claim 9, wherein the instructions, when executed by the one or more processors, further cause the computing device to:
determine whether a maximum angle value observed during a calibration procedure is in the first angle data or the second angle data; and
determine the direction of rotation based on which of the first angle data or second angle data includes the maximum angle value observed during the calibration procedure.

13. The non-transitory machine-readable storage medium of claim 9, wherein the instructions, when executed by the one or more processors, further cause the computing device to:
determine whether a minimum angle value observed during a calibration procedure is in the first angle data or the second angle data; and
determine the direction of rotation based on which of the first angle data or second angle data includes the minimum angle value observed during the calibration procedure.

14. The non-transitory machine-readable storage medium of claim 9, wherein the instructions, when executed by the one or more processors, further cause the computing device to determine, using the first angle data and the second angle data, a difference between a maximum extended angle associated with the rear suspension and a maximum compressed angle associated with the rear suspension, wherein the calibration data further comprises the difference.

15. The non-transitory machine-readable storage medium of claim 9, wherein the instructions, when executed by the one or more processors, further cause the computing device to:
determine that bicycle specification data associated with the bicycle is not available;
generate a user prompt to fully compress the rear suspension, wherein the second sensor data represents angle sensor samples generated during a time period to fully compress the rear suspension; and
determine a maximum compressed angle value for the rear suspension based on the second sensor data.

16. The non-transitory machine-readable storage medium of claim 9, wherein the instructions, when executed by the one or more processors, further cause the computing device to:
determine that bicycle specification data associated with the bicycle is available; and
determine a maximum compressed angle value for the rear suspension based on the bicycle specification data.

17. A computer-implemented method comprising:
under control of a computing device comprising one or more processors configured to execute specific instructions:
generating, using first sensor data from an angle sensor coupled to a bicycle, first angle data representing an extended state of a rear suspension of the bicycle;
generating, using second sensor data from the angle sensor, second angle data representing a compressed state of the rear suspension;
generating, using the first angle data and the second angle data, calibration data representing:
a direction of rotation detected by the angle sensor; and
a flag regarding whether the angle sensor has detected rotation past a checkpoint; and
generating performance data based on the calibration data and third sensor data from the angle sensor.

18. The computer-implemented method of claim 17, further comprising:
determine whether at least a first angle represented by the first sensor data is in a first sector of angles on a first side of the checkpoint, wherein the checkpoint corresponds to a zero reference point within a range of possible angles;
determine whether at least a second angle represented by the second sensor data is in a second sector of angles on a second side of the checkpoint; and
based on the first angle being in the first sector and the second angle being in the second sector, determine a value for the flag indicating the angle sensor has detected rotation past the checkpoint.

19. The computer-implemented method of claim 18, further comprising adjusting values of angles in the first sector of angles based on the flag.

20. The computer-implemented method of claim 17, further comprising determining, using the first angle data and the second angle data, a difference between a maximum extended angle associated with the rear suspension and a maximum compressed angle associated with the rear suspension, wherein the calibration data further comprises the difference.
